(19) United States
(12) Patent Application Publication
(10) Pub. No.: US 2015/0293391 A1
(43) Pub. Date: Oct. 15, 2015

(54) BRIGHTNESS ENHANCEMENT FILM, POLARIZING PLATE AND IMAGE DISPLAY DEVICE

(71) Applicant: FUJIFILM CORPORATION, Tokyo (JP)

(72) Inventors: Yujiro YANAI, Kanagawa (JP); Hiroshi SATO, Kanagawa (JP)

(73) Assignee: FUJIFILM CORPORATION, Tokyo (JP)

(21) Appl. No.: 14/681,658

(22) Filed: Apr. 8, 2015

(30) Foreign Application Priority Data
Apr. 9, 2014 (JP) 2014-080596

(51) Int. Cl. G02F 1/13363; G02F 1/1335; G02B 5/30

(52) U.S. Cl. CPC G02F 1/13363; G02B 5/3016; G02F 1/133528

(57) ABSTRACT

An aspect of the present invention relates to a brightness enhancement film, which includes two or more high refractive index layers and two or more low refractive index layers, each of the low refractive index layers having an average refractive index lower than those of the high refractive index layers, with the high refractive index layer and the low refractive index layer being alternately laminated, wherein at least one of the high refractive index layers is an optically-anisotoropic layer including a lyotropic liquid-crystalline compound and has an average refractive index of equal to or higher than 1.50 but equal to or less than 2.50.

### CROSS-REFERENCE TO RELATED APPLICATIONS

This application claims priority under 35 U.S.C. 119 to Japanese Patent Application No. 2014-080596 filed on Apr. 9, 2014. The above application is hereby expressly incorporated by reference, in its entirety.

### BACKGROUND OF THE INVENTION

1. Field of the Invention

The present invention relates to a brightness enhancement film, a polarizing plate comprising the brightness enhancement film, and an image display device.

2. Discussion of the Background

Image display devices such as liquid crystal display devices (also referred to as “LCDs” hereinafter) normally comprise at least an image display element such as a liquid crystal cell and a backlight unit.

As the energy consumption of backlight units has been reduced, it has been proposed that a multilayer film capable of enhancing brightness (the degree of brightness per unit area) be disposed between the backlight unit and the image display element to increase the rate of use of the light emitted by the light source contained in the backlight unit (for example, see Japanese Patent No. 3,448,626, which is expressly incorporated herein by reference in its entirety). Such a multilayer film is called a brightness enhancement film. An example of a commercial product is the DBEF series made by Sumitomo 3M. These brightness enhancement films are expected to become core parts of low power image display devices as mobile devices increase in number and the power consumption of household appliance products decreases.

### SUMMARY OF THE INVENTION

From the perspective of ease of portability, the requirement of reducing thickness has been high in the small and medium LCD markets for the tablet terminals and mobile applications that have been spreading rapidly in recent years. In the large LCD market centered on televisions, as well, there has been a need to reduce thickness to facilitate transportation and reduce transportation costs. In these circumstances, investigation has been conducted into how to reduce the thickness of image display devices by various means, such as by reducing the thickness of parts that constitute image display devices, including LCDs, and reducing the number of parts through the functional integration of parts.

To respond to the requirement of reducing the thickness of image display devices, it is desirable to reduce the thickness of the brightness enhancement films that are built into image display devices.

An aspect of the present invention provides for a new means of reducing the thickness of brightness enhancement films.

In the multilayer film described in Examples of Japanese Patent No. 3,448,626, several hundred layers of alternating high refractive index layers and low refractive index layers are laminated. DBEF series made by Sumitomo 3M, as well, which is an example of a commercial product, are formed by laminating many layers of differing refractive index. This is because it has conventionally been difficult to achieve adequately enhanced brightness without laminating many layers.

In this regard, the present inventors conducted extensive research. As a result, they discovered the following brightness enhancement film, which employs a high refractive index layer in the form of an optically-anisotropic layer containing a lyotropic liquid-crystalline compound that has not been conventionally employed to form brightness enhancement films:

a brightness enhancement film, which comprises two or more high refractive index layers and two or more low refractive index layers, each of the low refractive index layers having an average refractive index lower than those of the high refractive index layers, with the high refractive index layer and the low refractive index layer being alternately laminated, wherein at least one of the high refractive index layers is an optically-anisotoropic layer comprising a lyotropic liquid-crystalline compound and has an average refractive index of equal to or higher than 1.50 but equal to or less than 2.50.

That is, the present inventors discovered that it was possible to reduce the number of laminated layers relative to conventional brightness enhancement films and thus reduce the thickness, by using a lyotropic liquid-crystalline compound, which has conventionally not been employed as a material in brightness enhancement films, to form a high refractive index layer in a brightness enhancement film. The present inventors presume one reason for this to be that a liquid-crystal layer in which a lyotropic liquid-crystalline compound is oriented can exhibit high optical anisotropy. However, this is merely conjecture by the present inventors, and does not limit the present invention in any way.

In the present invention, the term “lyotropic liquid crystallinity” refers to the property of causing an isotropic phase—liquid-crystalline phase shift by changing the temperature and/or concentration when in a solution state in the presence of solvent. Accordingly, a solution at a temperature and concentration at which a lyotropic liquid-crystalline compound is present in a liquid crystal phase can be used to form a layer (liquid crystal layer) containing the liquid crystal phase. The details of lyotropic liquid-crystalline compounds will be set forth further below.

In the present invention, the average refractive index of a given layer refers to the average of the refractive index nx in an in-plane slow axis direction, the refractive index ny in an in-plane fast axis direction orthogonal to the slow axis direction, and the refractive index nz in a direction that is orthogonal to the slow axis direction and the fast axis direction.

The refractive indexes nx and ny can be measured by known refractive index measurement apparatus. An example of a refractive index measurement apparatus is the DR-M2 multi-wavelength Abbe refractometer made by Atago Corp. The refractive index nz can be calculated in the manner described further below from the layer thickness, retardation in an in-plane direction, and the values of refractive indexes nx and ny.

When there is no slow axis, the average value of the refractive index in the in-plane direction, the refractive index in the thickness direction, and the refractive index in a direction orthogonal to the in-plane direction and thickness direction is adopted as the average refractive index. The average refractive index in the various directions in this case can be obtained with a conventional refractive index measurement apparatus, such as the above DR-M2 multi-wavelength Abbe refractometer made by Atago Corp.

In an embodiment, the total number of high refractive index layers and low refractive index layers in the brightness enhancement film is equal to or less than 60 layers.

In an embodiment, the total number of high refractive index layers and low refractive index layers in the brightness enhancement film is equal to or less than 10 layers.

In an embodiment, the total thickness of the brightness enhancement film is equal to or less than 20.00 μm.

In an embodiment, the average refractive index differential between the optically-anisotropic layer and the low refractive index layer adjacent to the optically-anisotropic layer is equal to or higher than 0.05 in the brightness enhancement film. In an embodiment, no other layer is present between two adjacent layers. In another embodiment, an intermediate layer such as an adhesion-enhancing layer or an adhesive layer for adhering the two layers can be present between two layers.

In an embodiment, the average refractive index of the low refractive index layer adjacent to an optically-anisotropy layer is equal to or higher than 1.00 but less than 1.50 in the brightness enhancement film.

In an embodiment, the difference (nx−ny) between the refractive index nx in the in-plane slow axis direction and the refractive index ny in the in-plane fast axis direction is equal to or higher than 0.30.

In an embodiment, the low refractive index layer adjacent to the optically-anisotropic layer is an optically-isotropic layer. The term “optical-isotropy” as is known, refers to not exhibiting birefringence and will be described in detail further below. The term “optical anisotropy” as is known, refers to exhibiting birefringence. In an optically-anisotropic layer, this lies in the relation nx>ny between the refractive index nx in the in-plane slow axis direction and the refractive ny in the in-plane fast axis direction.

A further aspect of the present invention relates to a polarizing plate comprising the above brightness enhancement film and a polarizer layer.

In an embodiment, the polarizing plate is a backlight-side polarizing plate.

A further aspect of the present invention relates to an image display device, comprising an image display element and a backlight unit, and comprising the above brightness enhancement film between the image display element and the backlight unit.

In an embodiment, the image display element is a liquid crystal cell positioned between a viewing-side polarizing plate and a backlight-side polarizing plate, with the backlight-side polarizing plate comprising a polarizer layer and the above brightness enhancement film

In an embodiment, the brightness enhancement film is contained at a position closer to a backlight side than the polarizer layer in the backlight-side polarizing plate.

An aspect of the present invention can make it possible to reduce the number of laminated layers in a brightness enhancement film comprised of a multilayer film and to reduce the thickness of the brightness enhancement film.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the drawing, wherein:

FIG. 1 is a descriptive drawing of the method of measuring retardation in the in-plane direction of various layers contained in a multilayer film.

### DETAILED DESCRIPTION OF THE EMBODIMENTS

The description given below is based on representative forms of implementing the present invention. The present invention is not limited to such implementation forms. In the present invention and present specification, a numeric range denoted using the word “to” means a range that includes the preceding and succeeding numeric values as a lower limit and upper limit, respectively.

Brightness Enhancement Film

The brightness enhancement film according to an aspect of the present invention comprises two or more high refractive index layers and two or more low refractive index layers, each of the low refractive index layers having an average refractive index lower than those of the high refractive index layers, with the high refractive index layer and the low refractive index layer being alternately laminated, wherein at least one of the high refractive index layers is an optically-anisotoropic layer comprising a lyotropic liquid-crystalline compound and has an average refractive index of equal to or higher than 1.50 but equal to or less than 2.50.

The above brightness enhancement film will be described in greater detail below.

The term “brightness enhancement film” refers to a functional film that is capable of exhibiting a function of heightening the brightness of the display surface of an image display device relative to when the film is not contained. In the brightness enhancement film according to an aspect of the present invention, the function of a reflective polarizer is desirably present. The term “reflective polarizer” refers to having the function of reflecting light in a first state of polarization among the entering light, and passing light in a second state of polarization. The direction and polarization state of light of the first state of polarization that is reflected by the reflecting polarizer are randomized by a reflecting member (also referred to as a light guide plate, light guide, or optical resonator) contained in the backlight unit, and recirculated. Thus, the brightness of the display surface of the image display device can be enhanced. A multilayer film, in which are laminated a high refractive index layer exhibiting optical anisotropy and a low refractive index layer with a refractive index that is lower than in the high refractive index layer, can function as such a reflective polarizer. Usually, such a reflective polarizer can emit linear polarized light. In the brightness enhancement film according to an aspect of the present invention, a high refractive index layer exhibiting optical anisotropy is contained in the form of one or more optically-anisotropic layers containing a lyotropic liquid-crystalline compound and having the above-stated average refractive index.

Lyotropic Liquid-Crystalline Compound and Optically-Anisotropic Layer Containing the Lyotropic Liquid-Crystalline Compound

### (Lyotropic Liquid-Crystalline Compound)

One or more optically-anisotropic layers that are contained in the brightness enhancement film contain a lyotropic liquid-crystalline compound. The properties of lyotropic liquid crystallinity are as set forth above. The term “lyotropic liquid-crystalline compound” is a liquid-crystal compound possessing such properties. The lyotropic liquid-crystalline compound does not have to exhibit liquid-crystalline properties in the optically-anisotropic layer formed using this compound.

Examples of lyotropic liquid-crystalline compounds are azo compounds, anthraquinone compounds, perylene compounds, quinophthalone compounds, naphthoquinone compounds, and metallocyanine compounds. However, any compound that exhibits lyotropic liquid-crystalline properties will do, and use is not limited to the above compounds. Specific examples are the organic compounds denoted by general structural formulas I and II described in Japanese Translated PCT Patent Application Publication (TOKUHYO) No. 2012-500316, which is expressly incorporated herein by reference in its entirety. Reference can be made to paragraphs 0031 to 0086 and Examples of Japanese Translated PCT Patent Application Publication (TOKUHYO) No. 2012-500316 for details regarding the structures and synthesis methods of these organic compounds.

In an embodiment, examples of lyotropic liquid-crystalline compounds are compounds having one or more of the following structures:

a structure comprising two or more arylene groups;

a structure comprising two or more arylene groups, with a divalent connecting group denoted by —NH—C(═O)- being present between the two arylene groups; and

a structure comprising one or more arylene groups substituted with one or more substituents selected from the group consisting of sulfonic acid groups (—SO₃H) and sulfonic acid alkali metal salt groups (—SO₃M, where M denotes an alkali metal atom).

The above arylene groups are, for example, arylene groups with 6 to 30 carbon atoms, desirably arylene groups with 6 to 14 carbon atoms, and preferably, arylene groups with 6 to 10 carbon atoms. Specific examples are phenylene groups and naphthalene groups.

In the present invention, unless specifically stated otherwise, the groups that are mentioned can be substituted or unsubstituted. When a given group comprises at least a substituent, examples of the substituent are alkyl groups (such as alkyl groups having 1 to 6 carbon atoms), hydroxyl groups, alkoxy groups (such as alkoxy groups having 1 to 6 carbon atoms), halogen atoms (such as fluorine atoms, chlorine atoms, and bromine atoms), cyano groups, amino groups, nitro groups, acyl groups, and carboxyl groups. Accordingly, the above arylene groups can comprise one or more substituents. Specific examples of the substituents have been given above. As set forth above, the sulfonic acid groups and sulfonic acid alkali metal salt groups can be substituted. The number of substituents selected from the group consisting of sulfonic acid groups and sulfonic acid alkali metal salt groups that are substituted on a single arylene group is, for example, 1 to 3, and desirably 1. In the present invention, the “number of carbon atoms” of a group having a substituent means the number of carbon atoms of the portion without the substituent.

Examples of lyotropic liquid-crystalline compounds are compounds that have, or do not have, one or more of the above structures, and which have a structure comprising one or more divalent heterocyclic groups. Examples of divalent heterocyclic groups are desirably divalent heterocyclic groups having 1 to 26 carbon atoms, preferably divalent heterocyclic groups having 1 to 24 carbon atoms, more preferably five-membered or six-membered divalent heterocyclic groups. The hetero ring that is contained in the heterocyclic group can be a single ring or a fused ring. Examples of divalent heterocyclic groups are benzimidazolone groups, triazine groups, pyrimidine groups, quinoxaline groups, anthraquinone groups, quinophthalone groups, and benzophenone groups.

The lyotropic liquid-crystalline compound can be a polymer comprising two or more identical structural units (repeating units) or a copolymer comprising two or more different repeating units. The molecular weight of the lyotropic liquid-crystalline compound is, for example, equal to or higher than 5,000 but equal to or less than 10,000,000; there is no specific limitation. The term “molecular weight,” in the case of a polymer or copolymer, refers to the weight average molecular weight, obtained by measurement by gel permeation chromatography (GPC) and standard polystyrene conversion. The measurement can be conducted under the conditions given in Examples further below, for example.

A compound containing a polymerizable group (polymerizable compound) can be employed as the lyotropic liquid-crystalline compound. The polymerizable group is not specifically limited. Examples are radical polymerizable groups and cationic polymerizable groups. Examples of radical polymerizable groups are (meth)acryloyl groups, (meth)acryloyloxy groups, vinyl groups, styryl groups, and allyl groups. Examples of cationic polymerizable groups are vinyl ether groups, oxiranyl groups, and oxetanyl groups. The term (meth)acryloyl group” is a concept that includes both acryloyl groups and methacryloyl groups. The same applies to (meth)acryloyloxy groups. When the lyotropic liquid-crystalline compound is a polymerizable compound, one or more polymerizable groups can be contained per molecule.

The lyotropic liquid-crystalline compound can be synthesized by known methods and is available in the form of commercial products.

Optically-Anisotropic Layer Containing the Lyotropic Liquid-Crystalline Compound)

(i) Average Refractive Index

The optically-anisotropic layer containing the above-described lyotropic liquid-crystalline compound is a high refractive index layer with an average refractive index of equal to or higher than 1.50 but equal to or less than 2.50. Having an average refractive index of equal to or higher than 1.50 can promote the function as a high refractive index layer exhibiting optical anisotropy in the brightness enhancement film. The average refractive index of the optically-anisotropic layer is preferably equal to or higher than 1.60. From the perspective of achieving good brightness enhancement, the average refractive index of the optically-anisotropic layer is set to equal to or less than 2.50, desirably equal to or less than 2.30. The average refractive index of the optically-anisotropic layer is determined based on the type of lyotropic liquid-crystalline compound, so it suffices to select a lyotropic liquid-crystalline compound that can be formed into an optically-isotropic layer having the average refractive index desired.

(ii) Optical Anisotropy

As stated above, the term “optical anisotropy” lies in the relation nx>ny between the refractive index nx in the in-plane slow axis direction and the refractive ny in the in-plane fast axis direction. The slow axis is determined by a known phase difference measurement apparatus. Examples of phase difference measurement apparatus that can be used are the KOBRA CCD series, KOBRA 21ADH, and WR series of phase difference measurement apparatus made by OJI Scientific Instruments. As set forth above, nx and ny can be measured with known refractive index measurement apparatus.

Above-mentioned refractive index nz can be obtained from the retardation Re in the in-plane direction, layer thickness, and nx and ny. In-plane direction retardation Re is the retardation that is measured by directing light with a wavelength of λnm orthogonally onto the surface of the layer using a known phase difference measurement apparatus. In the present invention, 550 nm is adopted as the wavelength λnm.. In selecting measurement wavelength λnm, measurement can be made either by manually switching out the wavelength selection filter or switching the measurement value with a program or the like. The refractive index also refers to the refractive index of light with a wavelength of 550 nm.

The refractive index nz in a direction orthogonal to the in-plane slow axis direction and fast axis direction can be calculated based on the values of refractive index nx in the in-plane slow axis direction, the value of refractive index ny in the in-plane fast axis direction, the layer thickness d, and the in-plane direction retardation Re. The layer thickness can be obtained by observing a cross section with a microscope such as an optical microscope or a scanning electron microscope (SEM).

$$Re ( θ ) = [ nx - \frac{( ny \times nz )}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Equation ( 1 )$$

The Re (θ) denotes the retardation value in a direction inclined by an angle θ from the normal direction of the layer being measured. Accordingly, the in-plane direction retardation is θ=0 °.

In the present invention and the present specification, description relating to angles that are orthogonal and the like are considered to include the scope of error that is permitted in the technical field to which the invention belongs. For example, it means falling within a range of less than ±10° of the exact angle. The error with the exact angle is desirably equal to or less than 5° , preferably equal to or less than 3° .

The term “optically-isotropic layer” means a layer that does not exhibit birefringence, which in the present invention, for light of a wavelength of 550 nm, means a layer having an absolute value of in-plane direction retardation Re of equal to or higher than 0 nm but equal to or less than 10 nm, and an absolute value of retardation Rth in the thickness direction of equal to or higher than 0 nm but equal to or less than 10 nm. This desirably means an absolute value of retardation Re in the in-plane direction of equal to or higher than 0 nm but equal to or less than 5 nm, and an absolute value of Rth in the thickness direction of equal to or higher than 0 nm but equal to or less than 5 nm.

The retardation Rth in the thickness direction is calculated by a phase difference measurement apparatus based on measured retardation values, the average refractive index, the inputted layer thickness, and equation (1). The measurements are taken at a total of 6 points by directing 550 nm light to one side from the normal direction in steps of 10° in directions inclined up to 50° relative to the normal direction of the layer being measured, with the in-plane slow axis as the axis of inclination (rotation axis) (when the slow axis does not exist, some in-plane direction in the layer being measured is adopted as a rotation axis).

In the above, in the case of a layer having a direction in which the retardation value goes to zero at some inclination angle with the in-plane slow axis as the rotation axis from the normal direction, the sign of the retardation value at an angle of inclination greater than that angle of inclination is changed to negative and the calculation is performed by a phase difference measurement apparatus.

The retardation value can be measured in two directions inclined by some amount with the slow axis as the axis of inclination (rotation axis) (when the slow axis does not exist, some in-plane direction in the layer being measures is adopted as a rotation axis). The Rth can also be calculated based on these values, the average refractive index, a value inputted for the layer thickness, equation (1), and equation (2) below.

Rth=((nx+ny)/2-nz)x d Equation (2)

When the layer being measured cannot be represented by a refractive index ellipsoid with one or two axes, that is, when there is no optical axis, the Rth is calculated by the following method.

Re is measured at 11 points by directing 550 nm light from inclined directions in steps of 10° from −50° to +50° relative to the normal direction of the layer being measured with the in-plane slow axis being the axis of inclination (rotation axis). The phase difference measurement apparatus calculates Rth based on the retardation values measured, the average refractive index, and the value inputted for the layer thickness.

The retardation of the various layers in a multilayer film can be measured by the following method, for example.

A multilayer film that is to be measured is cut at an angle of incline of equal to or less than 1° relative to the surface of the multilayer film. For example, the cutting can be done with a rotary microtome (such as an RM42265 made by Leica).

The phase differences of minute regions of the samples obtained by cutting are then measured. Known minute area phase difference measurement apparatus, such as the KOBRA-CCD series of minute area phase difference measurement apparatus made by OJI Scientific Instruments, Inc, can be used to measure the minute area phase differences.

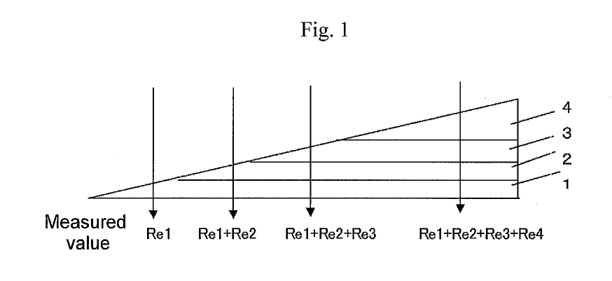

For example, with the samples cut from a multilayer film with the four-layer structure shown in FIG. 1, Re measurement is conducted at a total of four positions by measuring just the Re of the first layer 1 at the first position; measuring the Re of the first layer 1 and the second layer 2 at the second position; measuring the Re of the first layer 1, second layer 2, and third layer 3 at the third position; measuring the Re of the first layer 1, second layer 2, third layer 3, and fourth layer 4 at the fourth position. When the Re of the first layer is denoted as Re 1, the Re of the second layer is denoted as Re2, the Re of the third layer is denoted as Re3, and the Re of the fourth layer is denoted as Re4, as the first position measured, Re=Rel. At the second position measured, Re=Rel+Re2. At the third position measured, Re =Rel +Re2 +Re3. And at the fourth position measured, Re=Rel+Re2+Re3+Re4. Accordingly, Re2, Re3, and Re4 can be calculated by taking the difference in the Re measured for each position. Even when the number of layers contained in a multilayer film increases, it is possible to obtain the Re of each layer in this manner.

The above optically-anisotropic layer satisfies the relation nx >ny. The difference between nx and ny (nx-ny) is higher than 0. For example, it can be equal to or higher than 0.10. In terms of reducing the total number of high refractive index layers and low refractive index layers constituting the brightness enhancement film, it is desirable for the optical anisotropy of the optically-anisotropic layer to be large, that is, for the difference between nx and ny (nx−ny) to be great. From this perspective, the difference between nx and ny (nx−ny) is desirably equal to or higher than 0.30, preferably equal to or higher than 0.50, more preferably equal to or higher than 0.70, and still more preferably, equal to or higher than 0.80. The difference between nx and ny (nx−ny) can be, for example, equal to or less than 1.50. However, from the perspective of reducing the total number of layers, the larger it is the better, and the upper limit is not specifically limited.

The difference between nx and ny (nx−ny) in the optically-anisotropic layer can be increased by rendering the orientation of the lyotropic liquid-crystalline compound in the layers uniform. An example of a means of increasing the uniformity of orientation is, in the course of coating a coating liquid containing the lyotropic liquid-crystalline compound (lyotropic liquid-crystalline composition) on a surface to be coated to form the above optically-anisotropic layer, increasing the uniformity of orientation of the lyotropic liquid-crystalline compound within the layer being formed by applying as great a shear force as possible to the coating liquid. Examples of specific means of increasing the shear force are increasing the concentration of lyotropic liquid-crystalline compound in the coating liquid and increasing the coating rate in the course of applying the coating liquid. To orient the lyotropic liquid-crystalline compound within the layer, the temperature of the coating liquid during application is desirably made the temperature at which the lyotropic liquid-crystalline compound undergoes an isotropic phase—liquid crystal phase shift. Accordingly, the temperature of the coating liquid during application is desirably adjusted based on the type of lyotropic liquid-crystalline compound employed to form the optically-anisotropic layer. Further, the concentration of the lyotropic liquid-crystalline compound in the coating liquid can be set to within the concentration range at which the compound undergoes an isotropic phase—liquid crystal phase shift. Accordingly, the concentration of the lyotropic liquid-crystalline compound in the coating liquid is also desirably adjusted based on the type of lyotropic liquid-crystalline compound used to form the optically-anisotropic layer. The thickness and number of layers of the above optically-anisotropic layer will be set forth further below.

(iii) Lyotropic Liquid-Crystalline Composition (Coating Liquid)

The optically-anisotropic layer set forth above can be fabricated by coating a coating liquid containing a lyotropic liquid-crystalline compound (lyotropic liquid-crystalline composition) on a surface being coated. A single type of lyotropic liquid-crystalline compound can be employed, or a combination of two or more having different structures can be employed. The details of the coating process and the like are set forth further below. The lyotropic liquid-crystalline composition can be prepared by mixing the lyotropic liquid-crystalline compound with various additives and solvents as needed. Additives in the form of wavelength dispersion-controlling agents, optical characteristic modifiers, surfactants, adhesion enhancers, lubricants, orientation-controlling agents, UV absorbers, and other known additives that are commonly employed in liquid-crystalline compositions, can be employed without limitation.

The concentration of the lyotropic liquid-crystalline compound in the lyotropic liquid-crystalline composition is about 1 to 50 weight percent, for example. It suffices for the concentration to permit the lyotropic liquid-crystalline compound to undergo an isotropic phase—liquid crystal phase shift. The concentration can be determined based on the type of lyotropic liquid-crystalline compound employed, and is not limited to the above range. The temperature of the lyotropic liquid-crystalline composition during coating can be, for example, about 20 to 50° C. However, it suffices for the temperature to be one that permits the lyotropic liquid-crystalline composition to undergo an isotropic phase—liquid crystal phase shift. The temperature can be determined based on the type of lyotropic liquid-crystalline compound employed, and is not limited to the above range.

Examples of the solvent are water, dimethyl formamide, and other polar solvents; and hexane and other nonpolar solvents. These can be used singly or in any combination of two or more in any ratio. The solvent is desirably polar solvent, preferably water. As needed, acids and bases can be added to control the ion strength and pH.

Low Refractive Index Layer

The brightness enhancement film according to an aspect of the present invention is a multilayer film comprising two or more layers of each of alternating high refractive index layers and low refractive index layers, with at least one of the high refractive index layers being the above-described optically-anisotropic layer. The low refractive index layer need only be a layer having an average refractive index that is lower than that of the adjacent high refractive index layer, and is not specifically limited. Desirably, one or more of the low refractive index layers, preferably two or more layers, and more preferably, all of the low refractive index layers are optically-isotropic layers. Thus, combination with a high refractive index layer that is an optically-anisotropic layer can yield a multilayer film capable of performing the brightness enhancement function well.

The average refractive index of the low refractive index layer is desirably less than 1.50, preferably equal to or less than 1.45, more preferably equal to or less than 1.40, and still more preferably, equal to or less than 1.35. The difference in average refractive index between adjacent high refractive index and low refractive index layers is desirable large from the perspective of further enhancing brightness. The average refractive index of the low refractive index layer is desirably low to increase the average refractive index difference between adjacent high refractive index and low refractive index layers. On the other hand, the refractive index of the low refractive index layer is desirably equal to or higher than 1.00, preferably equal to or higher than 1.10, from the perspective of achieving good brightness enhancement.

The average difference in refractive index between the optically-anisotropic layer and adjacent low refractive index layer is desirably equal to or higher than 0.05, preferably equal to or higher than 0.10, more preferably equal to or higher than 0.20, still more preferably equal to or higher than 0.30, and yet still more preferably, equal to or higher than 0.35. When the brightness enhancement film contains a high refractive index layer other than the above-described optically-anisotropic layer, the difference in the refractive index between such a high refractive index layer and the adjacent low refractive index layer desirably also falls within the above-stated range. That is because the greater the average difference in refractive index between two adjacent layers, the greater the potential improvement in brightness. The average difference in refractive difference between two adjacent layers is, for example, equal to or less than 1.00. However, as stated above, the greater the better, and there is no specific limitation.

The average refractive index of the low refractive index layer can be adjusted by means of the refractive index of the materials employed to form the low refractive index layer, by adding inorganic particles to the low refractive index layer, and the like. Metal oxide particles are desirable as inorganic particles. Examples of metal oxides are titanium dioxide, zirconium oxide, zinc oxide, synthetic amorphous silica, colloidal silica, alumina, colloidal alumina, lead titanate, red lead, chrome yellow, zinc yellow, chromium oxide, ferric oxide, iron black, copper oxide, magnesium oxide, magnesium hydroxide, strontium titanate, yttrium oxide, niobium oxide, europium oxide, lanthanum oxide, zircon, and tin oxide.

The low refractive index layer can be formed by coating an aqueous coating liquid or a nonaqueous coating liquid, for example.

An aqueous coating liquid containing binder in the form of water-soluble binder can be employed. The term “water-soluble polymer” means, at the temperature of greatest solubility of the polymer, when adjusted to an aqueous solution of 0.5 weight percent, the weight of the insoluble matter when passed through a G2 glass filter (maximum pore size 40 to 80 μm) is equal to or less than 50 weight percent of the quantity of polymer added. The weight average molecular weight of the water-soluble polymer is desirably equal to or higher than 1,000 but equal to or less than 200,000, preferably equal to or higher than 3,000 but equal to or less than 40,000. Specific examples of water-soluble polymers are the various water-soluble polymers described in paragraph 0047 of WO 20012/014644A1, which is expressly incorporated herein by reference in its entirety. Polyvinyl alcohol is desirable. Any of the commercially available polyvinyl alcohol products can be employed without limitation. Reference can also be made to paragraphs 0048 to 0053 of WO 2012/014644A1 with regard to polyvinyl alcohol.

Inorganic polymer can also be contained in the aqueous coating liquid. Reference can be made to paragraphs 0054 to 0059 of WO 2012/014644A1 for details regarding inorganic polymers.

The aqueous coating liquid can also contain a curing agent to cure (crosslink) the water-soluble polymer. Any curing agent used to form a crosslinked structure with a water-soluble polymer can be employed without limitation. Examples of desirable curing agents are boric acid and boric acid salts. Boric acid and boric acid salts refer to oxoacids, and their salts, that have a boron atom as the central atom. Specific examples are orthoboric acid, diboric acid, metaboric acid, tetraboric acid, pentaboric acid, octaboric acid, and salts thereof. Known curing agents other than boric acid and boric acid salts can also be employed. Examples of such curing agents are those described in paragraph 0061 of WO 2012/014644A1. The quantity of curing agent employed is desirably 0.1 to 60 weight parts, preferably 10 to 60 weight parts, per 100 weight parts of water-soluble polymer.

The various components and additives described in paragraphs 0066 to 0077 and 0079 in WO 2012/014644A1 can also be contained in the aqueous coating liquid.

The aqueous coating liquid can be prepared by dissolving or suspending the various above components in a water-containing solvent, desirably in water. The quantity of solvent in the coating liquid is, for example equal to or more than 50 weight percent but equal to or less than 95 weight percent of the total coating liquid, but it suffices to be able to prepare a viscosity that can be coated, so the quantity is not specifically limited.

Examples of nonaqueous coating liquids are:

(1) compositions which comprise fluorine-containing compounds comprising at least one crosslinkable or polymerizable functional group;

(2) compositions containing principal components in the form of hydrolyzed condensates of fluorine-containing organosilane compounds; and

(3) compositions comprising inorganic particles and monomers having two or more ethylenic unsaturated groups.

Reference can be made to paragraphs 0052 to 0062 of Japanese Unexamined Patent Publication (KOKAI) No. 2012-78539, which is expressly incorporated herein by reference in its entirety, for details regarding the above compositions.

Method of Manufacturing the Brightness Enhancement Film >

The manufacturing method is not specifically limited beyond that the brightness enhancement film according to an aspect of the present invention has the structure set forth above. For example, an optically-anisotropic layer-forming coating liquid and a low refractive index layer-forming coating liquid can be sequentially or simultaneously multilayer coated on a surface being coated, and following coating, as needed, subjected to post-processing such as rinsing with water or the like and drying to obtain a brightness enhancement film in which high refractive index layers and low refractive index layers are laminated in alternating fashion. When employing a lyotropic liquid-crystalline compound having a polymerizable group, after coating, a polymerization treatment (heating, irradiation with light, or the like) based on the type of polymerizable group can be conducted to form an optically-anisotropic layer as a cured film. Various known coating methods can be employed to coat the various coating liquids. Specific examples of coating methods are curtain coating, extrusion coating, roll coating, dip coating, spin coating, print coating, spray coating, and slide coating. To control the orientation of the lyotropic liquid-crystalline compound, the lyotropic liquid-crystalline composition can be coated on a surface that has been subjected to a known orientation treatment such as a rubbing treatment. However, coating of the lyotropic liquid-crystalline composition can also be possible on a surface that has not been subjected to an orientation treatment because the orientation direction can be controlled with shear force by coating. Examples of coating methods that are suited to the application of shear force are curtain coating, extrusion coating, roll coating, and slide coating. Specifically, the use of a coating means such as a die coater, blade coater, or bar coater is desirable.

For example, in an embodiment, the surface that is coated can be the surface of a polarizer layer constituting a polarizing plate or the surface of a film such as a protective film provided on a polarizer layer. Coating the coating liquid on such a surface and forming a brightness enhancement film makes it possible to fabricate a polarizing plate in which a brightness enhancement film and a polarizer layer have been integrally laminated.

A coating in the form of the brightness enhancement film can be formed on a surface being coated, and the brightness enhancement film can be peeled off the surface being coated and disposed on the surface of a member constituting an image display device by means of an adhesion-enhancing layer or an adhesive layer, or adhered to the surface of a member, to incorporate the brightness enhancement film into an image display device. In that case, the surface being coated that is employed can be a known substrate such as glass or a polymer film, without limitation. Examples of polymer films are cellulose acylate films, acrylic films, norbornene films, and polyester films. However, this is not a limitation. Adhesion-enhancing layers and adhesive layers can also be formed with known adhesives. For example, an adhesion-enhancing layer or adhesive layer can be used to bond the surface of a brightness enhancement film and the surface of a polarizer layer or the surface of a film provided on a polarizer layer to fabricate a polarizing plate in which a brightness enhancement film and a polarizer layer have been integrally laminated.

In this context, the term “integrally laminated” is used to mean so as to exclude the state where that the brightness enhancement film has been simply positioned on the polarizer layer without coating or adhesion. For example, an embodiment in which coating liquids for forming the various layers constituting a brightness enhancement film are sequentially or simultaneously multilayer coated on the surface of a polarizer layer or on the surface of a film provided on the surface of a polarizer layer to form a brightness enhancement film; an embodiment in which an adhesion-enhancing layer, an adhesive layer, or other intermediate layer bonding two layers is used to tightly bond the surface of a polarizer layer or the surface of a film provided on a polarizer layer and the surface of a brightness enhancement film; an embodiment in which laminate processing employing an adhesive or laminate processing (hot pressing) not employing an adhesive is used to tightly bond the surface of a polarizer layer or the surface of a film provided on a polarizer layer to the surface of a brightness enhancement film; and the like are included in the term “integrally laminated.” The above manufacturing methods based on coating are desirable methods because they facilitate integral lamination.

Number of Laminated Layers, Total Thickness, and Thickness of Individual Layers

In the brightness enhancement film according to an aspect of the present invention, at least two high refractive index layers and two low refractive index layers are laminated in alternating fashion. Accordingly, the total number of high refractive index layers and low refractive index layers is at least four. As set forth above, by incorporating at least one high refractive index layer in the form of an optically-anisotropic layer with an average refractive index of equal to or higher than 1.50 but equal to or less than 2.50 containing a lyotropic liquid-crystalline compound, it is possible to develop an brightness enhancement function even with a lower number of laminated layers than is conventionally the case in a brightness enhancement film. The total number of high refractive index layers and low refractive index layers in the brightness enhancement film is desirably equal to or less than 60 layers, preferably equal to or less than 50 layers, and more preferably, equal to or less than 40 layers. The total number of high refractive index layers and low refractive index layers is, for example, equal to or more than 10 layers, or equal to or more than 20 layers; the fewer the laminated layers, the better. In the brightness enhancement film according to an aspect of the present invention, even a low number of laminated layers can develop a brightness enhancement function. However, it is possible for the number of laminated layers to be equivalent to that in a conventional brightness enhancement film. When the brightness enhancement film according to an aspect of the present invention has the conventional number of laminated layers, it can develop a brightness enhancement function that is superior to that of a conventional brightness enhancement film of the same number of laminated layers. From this perspective, a total number of high refractive index layers and low refractive index layers that is in excess of 60 layers, such as equal to or more than 100 layers and about equal to or less than 1,000 layers, is naturally possible.

It is also possible for the brightness enhancement film according to an aspect of the present invention to contain at least one high refractive index layer that is not an optically-anisotropic layer containing a lyotropic liquid-crystalline compound with an average refractive index of equal to or higher than 1.50 but equal to or less than 2.50. Examples of such high refractive index layers are the stretched films of various resin materials described from column 24, line 16 to column 25, line 18 in Japanese Patent No. 3,448,626. For details regarding stretching, reference can be made to the description in Examples and to column 6, line 34 to column 7, line 17 in Japanese Patent No. 3,448,626. Desirably, two or more of the high refractive index layers, preferably all of the high refractive index layers, can be an optically-anisotropic layer containing a lyotropic liquid-crystalline compound, with an average refractive index of equal to or higher than 1.50 but equal to or less than 2.50.

The multiple high refractive index layers and low refractive index layers contained in the brightness enhancement film can be layers formed of the same material or layers formed of different materials. The multiple high refractive index layers and low refractive index layers contained can be of the same layer thickness or can differ in layer thickness. The thickness of a single high refractive index layer, for example, falls within a range of 40 to 110 nm, and desirably falls within a range of 60 to 90 nm. The thickness of a single low refractive index layer, for example, falls within a range of 30 to 100 nm and desirably falls within a range of 50 to 80 nm.

From the perspective of reducing the thickness of the image display device incorporating the brightness enhancement film, the total thickness of the brightness enhancement film is desirably as thin as possible. For example, it is less than 30.00 μm, desirably equal to or less than 20.00 μm, preferably equal to or less than 15.00 μm, more preferably equal to or less than 10.00 μm, still more preferably equal to or less than 5.00 μm, and yet more preferably, equal to or less than 3.00 μm. The total thickness of the brightness enhancement film is, for example, equal to or more than 0.50 μm. However, because thickness reduction is desirable, there is no specific limitation.

The brightness enhancement film described above can be incorporated as a structural component of a backlight unit in an image display device in an embodiment. In another embodiment, it can be incorporated as a structural component of a polarizing plate in an image display device. The details will be given further below.

Polarizing Plate

The polarizing plate according to an aspect of the present invention contains the above brightness enhancement film and a polarizer layer.

In a liquid crystal display device, a liquid crystal cell is normally disposed between a viewing-side polarizing plate and a backlight-side polarizing plate. The above polarizing plate according to an aspect of the present invention can achieve brightness enhancement by increasing the amount of light entering the liquid crystal cell. Thus, it is desirably used as a backlight-side polarizing plate disposed between the liquid crystal cell and the backlight unit. The above brightness enhancement film is desirably disposed between a polarizer layer and a backlight unit. As set forth above, the above brightness enhancement film can be integrally laminated with the polarizer layer.

The above polarizing plate will be described in greater detail below.

Polarizer Layer

The polarizers commonly employed in polarizing plates can be employed without limitation as the polarizer layer. As a specific example, a polarizer layer that is obtained by immersing a polyvinyl alcohol film in an iodine solution and stretched can be employed. The thickness of the polarizer layer, for example, falls within a range of 0.5 to 80 μm, but is not specifically limited.

Protective films can be provided on one or both surfaces of the polarizer layer. The various protective films that are commonly employed on polarizing plates can be employed as the protective film without limitation. Specific examples are cellulose resins such as triacetyl cellulose, polyester resin, polyethersulfone resin, polysulfone resin, polycarbonate resin, polyamide resin, polyimide resin, polyolefin resin, acrylic resin, methacrylic resin, cyclic polyolefin resins (norbornene resin), polyallylate resin, polystyrene resin, polyvinyl alcohol resin, and mixtures thereof. At least one phase difference film can be present between the liquid crystal cell and the viewing-side polarizing plate and the backlight-side polarizing plate. For example, a phase difference film can be present as an inner polarizing plate protective film on the liquid crystal cell side. Known cellulose acylate films and the like can be employed as such a phase difference film.

The various films set forth above can be bonded to the polarizer layer and other films through known adhesion-enhancing layers and adhesive layers.

In an embodiment, the above brightness enhancement film can be provided on a film disposed on the polarizer layer. Generally, from the perspectives of workability such as strength and handling, as well as thickness reduction, the thickness of the protective film is about 1 to 500 μm, desirably 1 to 300 μm, more preferably 5 to 200 μm, and still more preferably, 5 to 150 μm. In both the viewing-side polarizing plate and the backlight-side polarizing plate, the polarizer layer can be bonded to the liquid crystal cell without an intervening protective film. The liquid crystal cell (particularly the substrate of the liquid crystal cell) can perform a protective function.

In another embodiment, the above brightness enhancement film can also serve as a protective film. For example, the brightness enhancement film can also serve as the backlight-side protective film of the backlight-side polarizing plate. Having such a brightness enhancement film play the role of a protective film is an effective way of reducing the thickness of the polarizing plate and image display device by integrating the functions of parts.

Image Display Device

The image display device according to an aspect of the present invention comprises:
an image display element and a backlight unit, and
the above brightness enhancement film between the image display element and the backlight unit.

Brightness Enhancement Film

As described in Japanese Patent No. 3,448,626, the brightness enhancement film has conventionally been disposed in an image display device as a separate part from the polarizing plate (see FIG. 2 in Japanese Patent No. 3,448,626, for example). In an embodiment, the above brightness enhancement film can be contained as a separate part from the polarizing plate in the above image display device.

In another embodiment, the above brightness enhancement film can be contained in the polarizing plate. The details of such a polarizing plate are as set forth above. For example, when the brightness enhancement film is contained in the backlight-side polarizing plate, it is desirably disposed at a position closer to a backlight side than the polarizer layer, preferably also serving as a backlight-side protective layer.

Image Display Elements

Examples of the image display element are the various known image display elements. Specific examples are liquid crystal cells (liquid crystal display elements), organic electroluminescence (EL) elements, and other EL display elements. The drive mode of the liquid crystal cells is not specifically limited. Examples are various modes such as in-plane switching (IPS) mode, fringe field switching (FFS) mode, and vertical alignment (VA) mode.

Backlight Unit

The backlight units commonly contained in image display units can be employed without limitation as the backlight unit. The backlight unit normally comprises at least a light source, and normally further comprises a light-guiding plate. The backlight unit can be configured as an edge-light type or direct type.

In an embodiment, the above brightness enhancement film can function as a reflective polarizer as set forth above. A reflective polarizer has the functions of passing light in a first state of polarization and reflecting light in a second state of polarization in the incident light. The light in a first state of polarization that passes through the reflective polarizer enters image display elements such as liquid crystal cells. Conversely, the direction and state of polarization of the light in a second state of polarization that is reflected by the reflective polarizer is randomized and reflected by a member having a reflective property, such as a light-guiding plate, that is contained in the backlight unit. This can make it possible to enhance the brightness of the display surface of the image display device.

### EXAMPLES

The present invention will be described more specifically based on Examples below. The materials, quantities employed, ratios, processing contents, processing procedures, and the like that are given in Examples below can be suitably modified without departing from the spirit or scope of the present invention. Accordingly, the scope of the present invention is not to be construed as being limited by the specific examples given below.

### Example 1

### 1. Preparation of Lyotropic Liquid-Crystalline Composition (Coating Liquid)

(1) Synthesis of Lyotropic Liquid-Crystalline Compound

The cesium salt of poly(2,2′-disulfo-4,4′-benzidineterephthalamide) having the repeating unit indicated below was synthesized by the following method as a lyotropic liquid-crystalline compound.

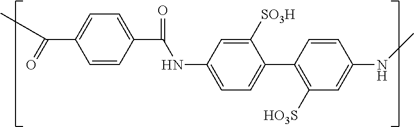

A 1.377 g (0.004 mol) quantity of 4,4′-diaminobiphenyl-2,2′-disulfonic acid was mixed with 1.2 g (0.008 mol) of cesium hydroxide and 40 mL of water and the mixture was stirred in a stirrer until it dissolved. Subsequently, 0.672 g (0.008 mol) of sodium hydrogencarbonate was admixed to the solution. While stirring the solution thus obtained at a stirring rate of 2,500 rpm, a solution of 0.812 g (0.004 mol) of terephthaloyldichloride in anhydrous toluene (15 mL) was gradually added in equal to or less than 5 minutes. Stirring was continued for another five minutes, yielding a viscous white emulsion. The emulsion thus obtained was diluted with 40 mL of water and the stirring speed was reduced to 100 rpm. The reaction product was homogenized, after which 250 mL of acetone was added to induce precipitation. The precipitating compound obtained had a weight average molecular weight of 1.7×10⁶. The weight average molecular weight was determined with an HLC-8120 made by Toso, a column in the form of a TSK gel Multipore HXL-M made by Toso (7.8 mm ID×30.0 cm), and eluent in the form of tetrahydrofuran (THF). The compound was identified by ¹H-NMR, confirming that the targeted compound had been obtained.

(2) Preparation of Lyotropic Liquid-Crystalline Composition (Coating Liquid)

The lyotropic liquid-crystalline compound synthesized in (1) above was added to pure water and an aqueous solution (lyotropic liquid-crystalline composition) was obtained at a 10 weight percent concentration.

A portion of the aqueous solution obtained was collected, coated at a solution temperature of 23° C. on a glass substrate with a bar coater, and dried to obtain a coating. The in-plane slow axis direction of the coating obtained was determined with a KOBRA-CCD series made by OJI Scientific Instruments to run perpendicular to the coating direction. The texture of the coating obtained was observed under a polarizing microscope and the presence of a liquid crystal phase was confirmed.

Based on the above results, the compound synthesized in (1) above was determined to be a compound exhibiting lyotropic liquid crystallinity.

2. Preparation of a Coating Liquid for Forming a low Refractive Index Layer

4.0 weight parts of polyvinyl alcohol (PVA 203 made by Kuraray Co., Ltd.) were dissolved in 50 weight parts of pure water, after which 5.0 weight parts of a 1.0 weight percent aqueous solution of boric acid adjusted to pH 3.0 with nitric acid and 100 weight parts of silica sol (Silicadol 20P made by Nippon Chemical) were added. The aqueous solution obtained was diluted with pure water to a total of 250 weight parts to prepare a coating liquid for forming a low refractive index layer.

3. Fabrication of a polarizer layer with protective film on one side

(1) Fabrication of protective film

### (Preparation of Core Layer Cellulose Acylate Dope 1)

The following composition was charged to a mixing tank and stirred. The various components were dissolved to prepare a core layer cellulose acylate dope 1. The molecular weight of compound 1-1 below was the weight average molecular weight determined by the method set forth above.

| | | |
|---|---|---|
| Cellulose acetate with a 2.88 degree | 100 | weight parts |
| of acetyl substitution | | |
| Ester oligomer (compound 1-1) | 10 | weight parts |
| Durability enhancer (compound 1-2) | 4 | weight parts |
| UV absorbent (compound 1-3) | 3 | weight parts |
| Methylene chloride (first solvent) | 438 | weight parts |
| Methanol (second solvent) | 65 | weight parts |

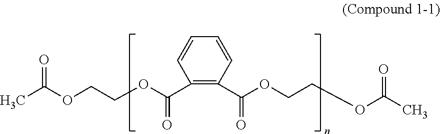

Molecular weight: 1000

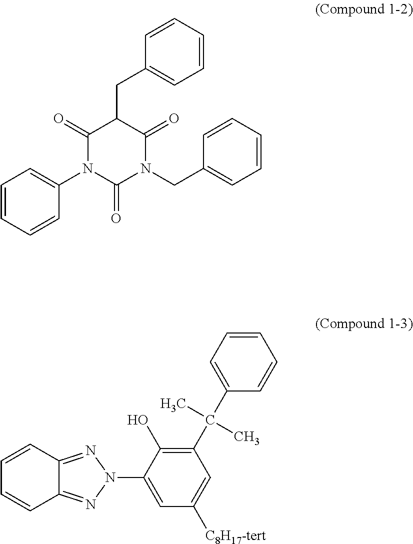

(Preparation of outer layer cellulose acylate dope 1

To the above core layer cellulose acylate dope 1 (90 weight parts) was added the following matting agent dispersion 1 (10 weight parts) to prepare an outer layer cellulose acylate dope 1.

| | | |
|---|---|---|
| Silica particles with an average particle | 2 | weight parts |
| size of 20 nm (Aerosil R972, made by | | |
| Nippon Aerosil) | | |
| Methylene chloride (first solvent) | 76 | weight parts |
| Methanol (second solvent) | 11 | weight parts |
| Core layer cellulose acylate dope 1 | 1 | weight part |

(Preparation of Cellulose Acylate Film)

Three layers consisting of core layer cellulose acylate dope 1 and to each side thereof outer layer cellulose acylate dope 1 were simultaneously caused to flow onto a drum at 20° C. through casting nozzles. In a state of about a 20 weight percent content of solvent, they were peeled off, two edges of the film in a width direction were secured with tenter clips, and the remaining solvent, in a state of 3 to 15 weight percent, was dried while conducting 1.2-fold stretching in a crosswise direction. Subsequently, by means of conveyance between the rolls of a heat treatment device, a cellulose acylate film 25 μm in thickness was fabricated as protective film 01.

(2) Preparation of Polarizer Layer with Protective Film on one Side

### (Saponification of Protective Film)

Protective film 01 fabricated in (1) above was immersed for 1 minute in a 4.5 mol/L sodium hydroxide aqueous solution (saponification solution) that had been adjusted to 37° C. The film was then rinsed with water, immersed for 30 seconds in a 0.05 mol/L sulfuric acid aqueous solution, and rinsed again with water. An air knife was then used to drain off the water three times. After removing the water, the film was placed for 15 seconds in a 70° C. drying zone and dried to prepare saponified protective film 01.

Fabrication of Polarizer Layer

An elongated polyvinyl alcohol film 75μm in thickness (9×75RS made by Kuraray) was continuously conveyed by guide rolls, swollen 1.5-fold by immersion in a 30° C. water bath, and stretched at a two-fold stretching rate. It was then dyed by immersion in an iodine and potassium iodide formulation dye bath (30° C.). Along with the dyeing, it was also stretched at a three-fold stretching rate. Next, it was subjected to a crosslinking treatment in an acidic bath (60° C.) to which boric acid and potassium iodide had been added and subjected to a stretching treatment at a 6.5-fold stretching rate. Subsequently, it was dried for 5 minutes at 50° C. to obtain a polarizing film (polarizer layer) 1,330 mm in width and 15 μm in thickness.

Bonding the Polarizer Layer and Protective Film

The polarizer layer obtained above and the protective film 01 that had been subjected to the saponification treatment were bonded together roll-to-roll so that the transmission axis of the polarizing film was perpendicular to the longitudinal direction of the protective film using an adhesive in the form of a 3 weight percent aqueous solution of polyvinyl alcohol (PVA-117H made by Kuraray) to fabricate a polarizing plate 01 with a protective film on one side (referred to hereinafter simply as polarizing plate 01).

4. Fabrication of Polarizing Plate with Brightness Enhancement Film

The lyotropic liquid-crystalline composition prepared in 1. above was coated with a bar coater on the side on which a protective film had not been formed of the polarizer layer with protective film on one side (polarizing plate 01) obtained in 3. above such that the slow axis of the optically-anisotropic layer that was formed was parallel to the absorption axis of polarizing plate 01. It was then rinsed with water and dried to form a first layer in the form of a high refractive index layer (optically-anisotropic layer).

The coating liquid for forming a low refractive index layer fabricated in 2. above was coated with a bar coater and dried on the surface of the first optically-anisotropic layer that had been formed to form a second layer in the form of low refractive index layer (SiO₂ layer).

Subsequently, in the same manner, optically-anisotropic layers and low refractive index layers were repeatedly formed to fabricate a brightness enhancement film having a total of 22 laminated layers (11 layers each) in which optically-anisotropic layers were alternated with low refractive index layers.

5. Fabrication of Liquid Crystal Display Device

The polarizing plate on the backlight side of a liquid crystal display device used on a commercial tablet terminal (iPad (Japanese registered trademark) Air (made by Apple)) was separated and in its place a polarizing plate with brightness enhancement film fabricated in Example 1 was bonded so that the brightness enhancement film was positioned on the backlight side.

6. Evaluation of Brightness Enhancement Film

### (1) White Brightness Evaluation

The brightness was measured with a color brightness meter BM-5 (made by Topcon) from directly in front with the liquid crystal display device fabricated in 5. above in a white display state, and a white brightness (about 300 cd/m²) roughly equivalent to the above commercial tablet terminal was determined.

(2) Measurement of the Thickness of the Optically-Anisotropic Layer and low Refractive Index Layer

The brightness enhancement film was separated from the polarizing plate fabricated in Example 1, a diagonal cut was made in the film surface, and a scanning electron microscope (SEM, S-3400N made by Hitachi High-Tech) was used to measure the thickness of each layer and the total thickness of the brightness enhancement film. The results are given in Table 1.

(3) Measurement of Retardation of low Refractive Index Layer and Optically-Anisotropic Layer

A sample obtained by forming on a glass substrate a single optically-anisotropic layer the same 78 nm in thickness as the optically-anisotropic layer contained in the brightness enhancement film, and a sample obtained by forming on a glass substrate a single low refractive index layer the same 68 nm in thickness as the low refractive index layer contained in the brightness enhancement film, were prepared by the same method as in Example 1.

The above sample containing an optically-anisotropic layer formed on a glass substrate was used to measure the retardation Re of the optically-anisotropic layer in the in-plane direction at a wavelength of 550 nm with a KOBRA-CCD series made by OJI Scientific Instruments. The results are given in Table 1.

Separately, when the above sample containing a low refractive index layer formed on a glass substrate was used to measure the in-plane retardation Re of the low refractive index layer at a wavelength of 550 nm with a KOBRA-CCD series made by OJI Scientific Instruments and the retardation Rth in the thickness direction was obtained by the method set forth above, the absolute values of the in-plane retardation Re and the retardation Rth in the direction of thickness were both equal to or higher than 0 nm but equal to or less than 5 nm. Thus, the low refractive index layer was determined to be an optically-isotropic layer.

(4) Calculation of the Average Refractive Index of the low Refractive Index Layer and the Optically-Anisotropic Layer

The average refractive indexes were obtained as average values of the refractive indexes in three directions in the form of the refractive indexes of the in-plane direction, thickness direction, and direction orthogonal to the in-plane direction and thickness direction with a DR-M2 multi-wavelength Abbe refractometer made by Atago in the above sample containing a low refractive index layer formed on a glass substrate.

The refractive indexes nx and ny in the in-plane slow axis direction and fast axis direction were obtained with a DR-M2 multi-wavelength Abbe refractometer made by Atago for the above sample containing an optically-anisotropic layer formed on a glass substrate. As set forth above, the refractive index nz was calculated based on these values, the retardation Re in the in-plane direction measured in (3) above, and the layer thickness, and the average refractive index was obtained as the average of nx, ny, and nz.

The results are given in Table 1.

The retardation was obtained above using a low refractive index layer and an optically-anisotropic layer fabricated on glass substrates. However, the retardation of the various layers contained in the brightness enhancement film can also be obtained by the method set forth above with reference to FIG. 1.

### Example 2

With the exception that the coating rate with the bar coater was increased in the course of forming the optically-anisotropic layer and the quantity of silica sol in the coating liquid for forming the low refractive index layer was increased, a polarizing plate equipped with a brightness enhancement film comprised of a total of a 22 layer lamination (11 layers each) of alternating optically-anisotropic layers and low refractive index layers and a liquid crystal display device equipped with this polarizing plate were fabricated by same method as in Example 1.

The same evaluation as in Example 1 was conducted on the brightness enhancement film and liquid crystal display device fabricated in Example 2. The results are given in Table 1. The evaluation results confirmed that the low refractive index layer fabricated in Example 2, in the same manner as the low refractive index layer fabricated in Example 1, was an optically-isotropic layer exhibiting absolute values for the in-plane direction retardation Re and thickness direction retardation Rth of equal to or higher than 0 nm but equal to or less than 5 nm. The results obtained are presented in Table 1.

White brightness evaluation was conducted on the liquid crystal display device fabricated in Example 2 by the same method as in Example 1. The results revealed a white brightness (of about 300 cd/m²) roughly equivalent to that of the above commercial tablet terminal.

A cross section of the backlight-side polarizing plate contained in the above commercial tablet terminal was observed by the SEM. The results revealed that a brightness enhancement film 30 μm in thickness comprised of a several hundred layer lamination was bonded to a polarizing plate through a 15 μm adhesive layer.

TABLE 1

| | High refractive index layer | | | | | | | | |
|---|---|---|---|---|---|---|---|---|---|
| | (optically-anisotropic layer) | | | | | Low refractive index layer | | | |
| | Average | | | | Single | Average | | Average | Total thickness of |
| | refractive | | | | layer | refractive | Single layer | refractive index | brightness |
| | index | nx | ny | nx − ny | thickness | index n_{L} | thickness | difference | enhancement film |
| Example 1 | 1.70 | 2.10 | 1.50 | 0.60 | 78 nm | 1.40 | 68 nm | 0.30 | 1.61 μm |
| Example 2 | 1.70 | 2.50 | 1.50 | 1.00 | 75 m | 1.30 | 65 nm | 0.40 | 1.54 μm |
| Reference | — | — | — | — | | — | | — | 30.00 μm |
| example | | | | | | | | | (bonded to |
| (brightness | | | | | | | | | polarizing layer |
| enhancement | | | | | | | | | backlight-side |
| film contained | | | | | | | | | protective film |
| in above | | | | | | | | | through adhesive |
| commercial | | | | | | | | | layer 15.00 μm in |
| tablet terminal) | | | | | | | | | thickness) |

As set forth above, the liquid crystal display device equipped with a polarizing plate with brightness enhancement film prepared in Examples 1 and 2 exhibited a white brightness roughly equivalent to that of a commercial liquid crystal display device.

As shown in Table 1, the number of laminations and the total thickness were greatly reduced in the brightness enhancement films prepared in Examples 1 and 2 over that of the brightness enhancement film contained in the commercial tablet terminal.

Based on these results, it was determined to be possible to reduce the number of laminations and the total thickness of the brightness enhancement film while achieving a brightness enhancement equivalent to that of a conventional brightness enhancement film.

A comparison of Examples 1 and 2 can reveal that it is possible to achieve an equivalent brightness enhancement with a reduction in overall thickness by increasing the value of (nx—ny) and the average refractive index difference between the high refractive index layer and the low refractive index layer.

An aspect of the present invention is useful in the field of manufacturing various image display devices such as liquid crystal display devices.

The present disclosure relates to the subject matter contained in Japanese Patent Application No. 2014-080596 filed on Apr. 9, 2014, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A brightness enhancement film, which comprises two or more high refractive index layers and two or more low refractive index layers, each of the low refractive index layers having an average refractive index lower than those of the high refractive index layers, with the high refractive index layer and the low refractive index layer being alternately laminated, wherein
at least one of the high refractive index layers is an optically-anisotoropic layer comprising a lyotropic liquid-crystalline compound and has an average refractive index of equal to or higher than 1.50 but equal to or less than 2.50.

2. The brightness enhancement film according to claim 1, wherein a total number of high refractive index layers and low refractive index layers is equal to or less than 60 layers.

3. The brightness enhancement film according to claim 1, wherein a total number of high refractive index layers and low refractive index layers is equal to or less than 10 layers.

4. The brightness enhancement film according to claim 1, the total thickness of which is equal to or less than 20.00 μm.

5. The brightness enhancement film according to claim 1, wherein an average refractive index differential between the optically-anisotropic layer and the low refractive index layer adjacent to the optically-anisotropic layer is equal to or higher than 0.05.

6. The brightness enhancement film according to claim 1, wherein an average refractive index differential between the optically-anisotropic layer and the low refractive index layer adjacent to the optically-anisotropic layer is equal to or higher than 1.00 but less than 1.50.

7. The brightness enhancement film according to claim 1, wherein, in the optically-anisotoropic layer, a difference, nx—ny, between a refractive index nx in an in-plane slow axis direction and a refractive index ny in an in-plane fast axis direction is equal to or higher than 0.30.

8. The brightness enhancement film according to claim 1, wherein the low refractive index layer adjacent to the optically-anisotropic layer is an optically-isotropic layer.

9. A polarizing plate, which comprises:
a brightness enhancement film, and
a polarizer layer, wherein
the brightness enhancement film is a brightness enhancement film which comprises two or more high refractive index layers and two or more low refractive index layers, each of the low refractive index layers having an average refractive index lower than those of the high refractive index layers, with the high refractive index layer and the low refractive index layer being alternately laminated, wherein
at least one of the high refractive index layers is an optically-anisotoropic layer comprising a lyotropic liquid-crystalline compound and has an average refractive index of equal to or higher than 1.50 but equal to or less than 2.50.

10. The polarizing plate according to claim 9, wherein, in the brightness enhancement film, a total number of high refractive index layers and low refractive index layers is equal to or less than 60 layers.

11. The polarizing plate according to claim 9, wherein, in the brightness enhancement film, a total number of high refractive index layers and low refractive index layers is equal to or less than 10 layers.

12. The polarizing plate according to claim 9, wherein a total thickness of the brightness enhancement film is equal to or less than 20.00 μm.

13. The polarizing plate according to claim 9, wherein, in the brightness enhancement film, an average refractive index differential between the optically-anisotropic layer and the low refractive index layer adjacent to the optically-anisotropic layer is equal to or higher than 0.05.

14. The polarizing plate according to claim 9, wherein, in the brightness enhancement film, an average refractive index differential between the optically-anisotropic layer and the low refractive index layer adjacent to the optically-anisotropic layer is equal to or higher than 1.00 but less than 1.50.

15. The polarizing plate according to claim 9, wherein, in the optically-anisotoropic layer of the brightness enhancement film, a difference, nx—ny, between a refractive index nx in an in-plane slow axis direction and a refractive index ny in an in-plane fast axis direction is equal to or higher than 0.30.

16. The polarizing plate according to claim 9, wherein, in the brightness enhancement film, the low refractive index layer adjacent to the optically-anisotropic layer is an optically-isotropic layer.

17. The polarizing plate according to claim 9, which is a backlight-side polarizing plate.

18. An image display device, which comprises:
an image display element,
a backlight unit, and
a brightness enhancement film between the image display element and the backlight unit, wherein
the brightness enhancement film is a brightness enhancement film which comprises two or more high refractive index layers and two or more low refractive index layers, each of the low refractive index layers having an average refractive index lower than those of the high refractive index layers, with the high refractive index layer and the low refractive index layer being alternately laminated, wherein
at least one of the high refractive index layers is an optically-anisotoropic layer comprising a lyotropic liquid-crystalline compound and has an average refractive index of equal to or higher than 1.50 but equal to or less than 2.50.

19. The image display device according to claim 18, wherein
the image display element is a liquid crystal cell positioned between a viewing-side polarizing plate and a backlight-side polarizing plate, with the backlight-side polarizing plate comprising a polarizer layer and the brightness enhancement film.

20. The image display device according to claim 19, wherein
the brightness enhancement film is comprised at a position closer to a backlight side than the polarizer layer in the backlight-side polarizing plate.
